(19) United States
(12) Patent Application Publication
(10) Pub. No.: US 2015/0207195 A1
(43) Pub. Date: Jul. 23, 2015

(54) CAVITY FILTER

(71) Applicant: Hon Hai Precision Industry Co., Ltd., New Taipei (TW)

(72) Inventor: KWO-JYR WONG, New Taipei (TW)

(73) Assignee: HON HAI PRECISION INDUSTRY CO., LTD., New Taipei (TW)

(21) Appl. No.: 14/198,639

(22) Filed: Mar. 6, 2014

(30) Foreign Application Priority Data
Jan. 22, 2014 (TW) 103102193

(51) Int. Cl. H01P 1/20

(52) U.S. Cl. CPC H01P 1/207

(57) ABSTRACT

A cavity filter includes a housing, a resonator pipe, an adjusting screw and a lid. The lid covers on the housing. The housing includes a bottom board. The resonator pipe is fixed on the bottom board. The resonator pipe and the bottom board define a screw thread hole. The adjusting screw rotated into the housing from open end of the screw thread hole to adjust the resonance frequency of the cavity filter. The resonator pipe and the bottom board define a screw thread hole and the adjusting screw rotated into the housing from open end of the screw thread hole to save the space of out of the housing of the cavity filter.

### BACKGROUND

1. Technical Field

The present disclosure relates to cavity filters, and more particularly to a cavity filter for saving the space of out of the cavity.

2. Description of Related Art

A cavity filter is a conventional module in communication devices. Generally, the cavity filter includes a lid and a plurality of houses. Each house corresponds to an oscillation circuit and defines at least one resonator pipe. The cavity filter includes a plurality of adjusting screws mounted on the lid. Thus, the surface of the lid is not flat because of the adjusting screws positioned on the lid, and it needs additional space out of the house to contain the adjusting screw.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a cross-sectional view in side elevation of a cavity filter in accordance with an embodiment of the present disclosure.

FIG. 2 is an isometric view of a housing and a resonator pipe of the cavity filter of FIG. 1.

FIG. 3 is an isometric view of an adjusting screw of the cavity filter of FIG. 1.

FIG. 4 is an isometric view of a resonator cup of the cavity filter of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.

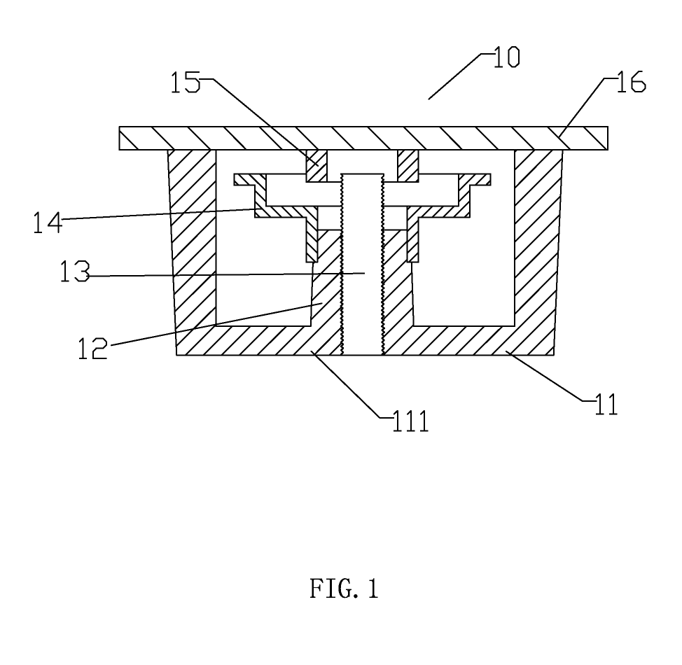

FIG. 1 shows a cavity filter 10 of one illustrated embodiment. The cavity filter 10 includes a housing 11, a resonator pipe 12, an adjusting screw 13, a resonator cup 14 and a lid 16. The lid 16 is a thin board and covers on the housing 11. The resonator pipe 12 and the housing 11 are formed integrally. An assistant ring 15 is fixed on a surface of the lid 16, and is positioned between the lid 16 and the adjusting screw 13. An inner diameter of the assistant ring 15 is larger than a cross-section diameter of the adjusting screw 13 for surrounding the adjusting screw 13 when the adjusting screw 13 is rotated into the assistant ring 15. The assistant ring 15 changes the projection area of the adjusting screw 13 into the lid 16 to gain the scope adjusted to adjust resonance frequency. Moreover, the assistant ring 15 is contained in the resonator cup 14 to save the space of the housing 11.

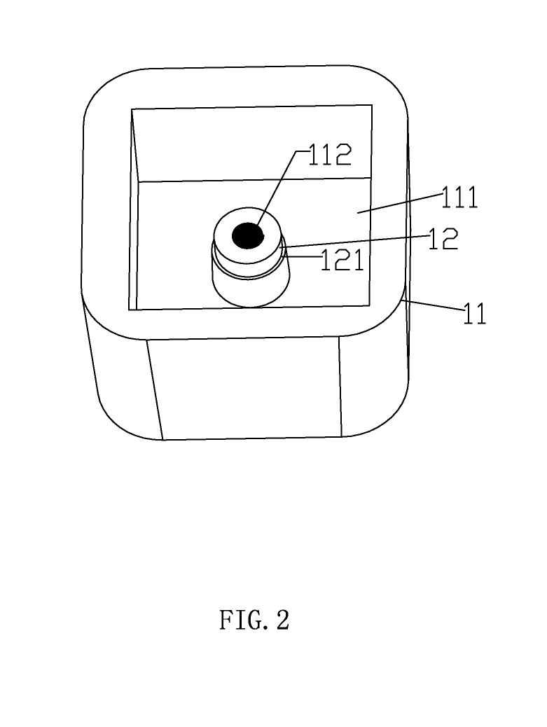

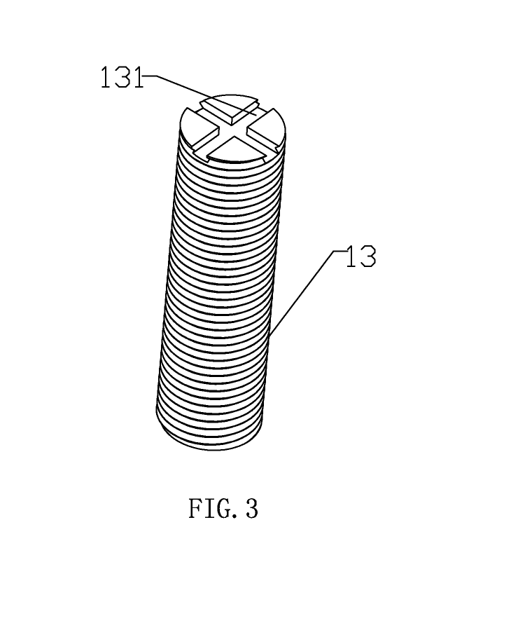

FIGS. 2 and 3 shows that the housing 11 includes a bottom board 111. The resonator pipe 12 is mainly a circular column. The resonator pipe 12 includes two circular columns with different sizes. The two circular columns form a step 121. The screw thread hole 112 drills through the resonator pipe 12 and the bottom board 111. A cross groove 131 replaces a screw cap on the adjusting screw 13 which is rotated with a screwdriver. The adjusting screw 13 is rotated into the housing 11 from the open end of the screw thread hole 112 for saving the space of out of the housing 11. The adjusting screw 13 is rotated to adjust the resonance frequency of the cavity filter 10.

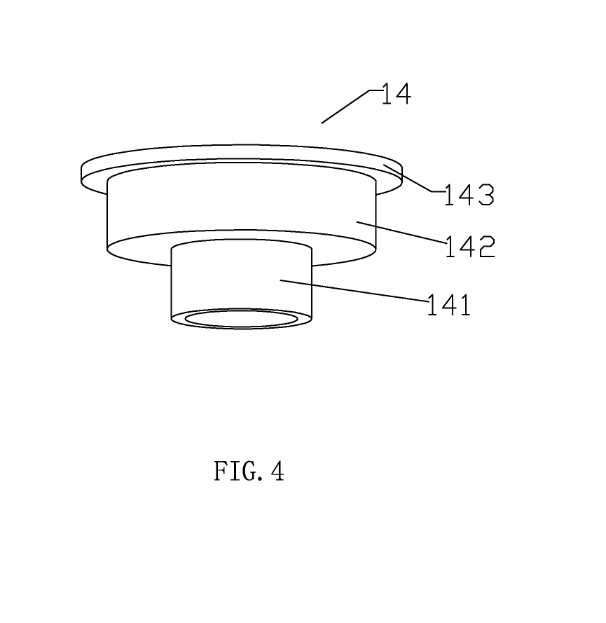

FIG. 4 shows that the resonator cup 14 is cup shaped, and defines a hole. The resonator cup 14 changes the resonance frequency of the cavity filter 10. The resonator cup 14 includes a first column 141, a second column 142 and an extended plane 143. The first column 141 and the second column 142 are two circular columns. The second column 142 is larger than the first column 141. The extended plane 143 extends from the second column 142 in a horizontal direction. In assembly, the resonator pipe 12 is surrounded by the first column 141, and the first column 141 is resisted by the step 121.

In the embodiment, the assistant ring 15 is fixed on the lid 16 by welding or other methods. The resonator cup 14 and the resonator pipe 12 are combined by welding.

In the embodiment, the bottom board 111 and the resonator pipe 12 are incorporate and made by die casting. Machining of the bottom board 111 and the resonator pipe 12 is finished after being made in die casting for assembly.

In the embodiment, the problem that the surface of the lid 16 is not flat is solved, and the adjusting screw 13 is rotated into the housing 11 from the open end of the screw thread hole 112 to save the space of out of the housing 11. In the present disclosure, the cavity filter 10 is appealing and the space of containing the cavity filter is saved.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A cavity filter, comprising:
a housing comprising a bottom board;
a lid covered on the housing; and
a resonator pipe fixed on the bottom board;
wherein the resonator pipe and the bottom board define a screw thread hole, an adjusting screw is screwed into the housing via an open end of the screw thread hole to adjust a resonance frequency of the cavity filter.

2. The cavity filter of the claim 1, further comprising an assistant ring, wherein the assistant ring is positioned between the lid and the adjusting screw, and the assistant ring is capable of increasing the scope of the resonance frequencies adjusted by the cavity filter.

3. The cavity filter of the claim 2, wherein an inner diameter of the assistant ring is larger than a cross-section diameter of the adjusting screw, and the assistant ring surrounds the adjusting screw.

4. The cavity filter of the claim 1, wherein the screw thread hole drills through the resonator pipe and the bottom board, and the adjusting screw is screwed into the housing via the open end of the screw thread hole, which is not beyond the cavity filter.

5. The cavity filter of the claim 1, wherein the adjusting screw defines a cross groove.

6. The cavity filter of the claim 1, further comprising a resonator cup, wherein the resonator cup is shaped as a cup, and the resonator cup defines a hole for surrounding the resonator pipe, and the resonator cup is welded on the resonator pipe.

7. The cavity filter of the claim 2, wherein the assistant ring is surrounded by the resonator cup to save the space of the inside of the housing.

8. The cavity filter of the claim 1, wherein the bottom board and the resonator pipe are integrated by die casting.

9. The cavity filter of claim 1, wherein the resonator pipe is welded on the bottom board.

10. The cavity filter of the claim 7, wherein the assistant ring is welded on the lid.
